(19) United States
(12) Patent Application Publication
(10) Pub. No.: US 2011/0309006 A1
(43) Pub. Date: Dec. 22, 2011

(54) Crouse oil spill trolling net and net frame

(76) Inventor: Timothy Christian Crouse, Murray, KY (US)

(21) Appl. No.: 13/134,490

(22) Filed: Jun. 7, 2011

Related U.S. Application Data
(60) Provisional application No. 61/397,214, filed on Jun. 7, 2010.

(51) Int. Cl. E02B 15/10; C02F 1/00; C02F 101/32

(52) U.S. Cl. 210/170.05; 210/242.3

(57) ABSTRACT

This is a net 405 and net frame 401 system which can be used to skim for oil, whereas the Netting 405 is designed specifically for a Net Frame 401. When skimming or trolling out beside a vessel or boat 300, the Netting or Net Bags 405 are made of a porous material and or weaving so to allow the water to pass through, but the oil. Because the oil cannot pass through, it is therefore is collected or trapped in the netting. The Net Frames 401 can resemble a simple crab traps and the Net Bags 405 can be attached in a similar way as a kitchen pale or like a trash bag in a trash can. Once the net bags 405 become filled with skimmed oil, they can be taken off, cinched or secured, and the thrown away or hauled off (etc.) while another fresh bag is put on or replaced. The old bags are towed to a dumping location where they are: disposed, cleaned and reused, burned, etc.

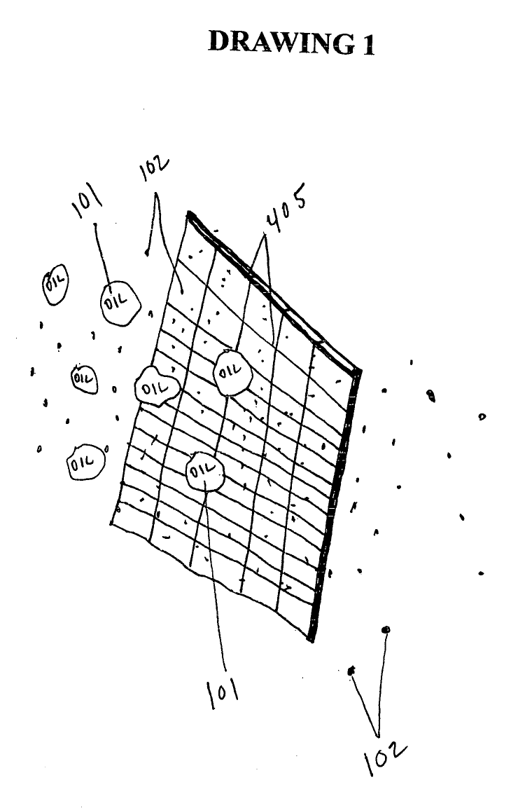

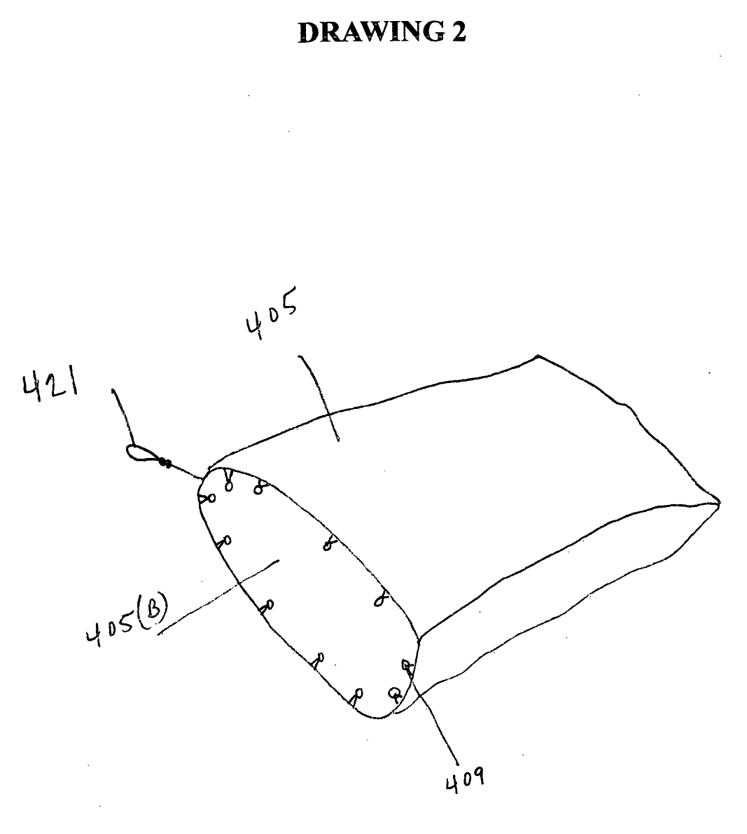

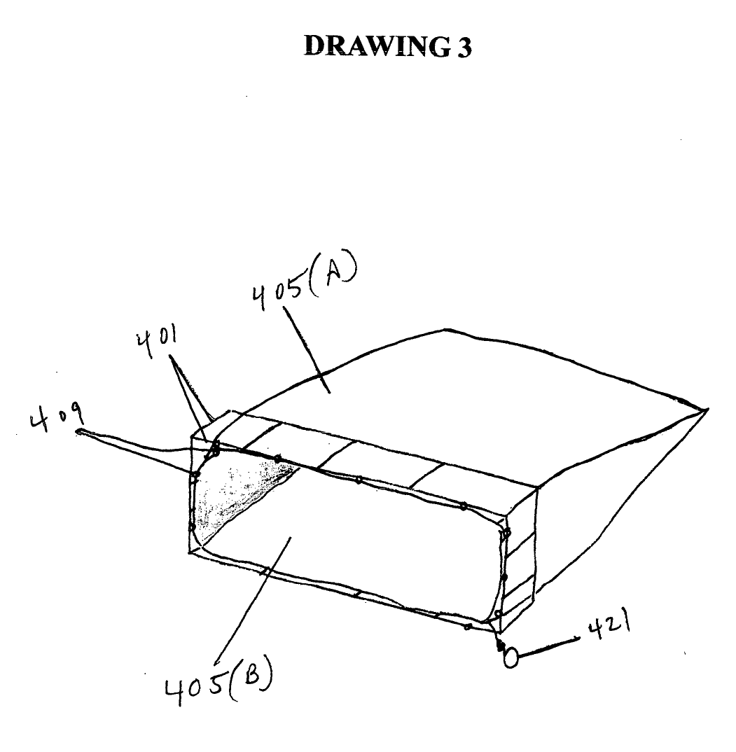

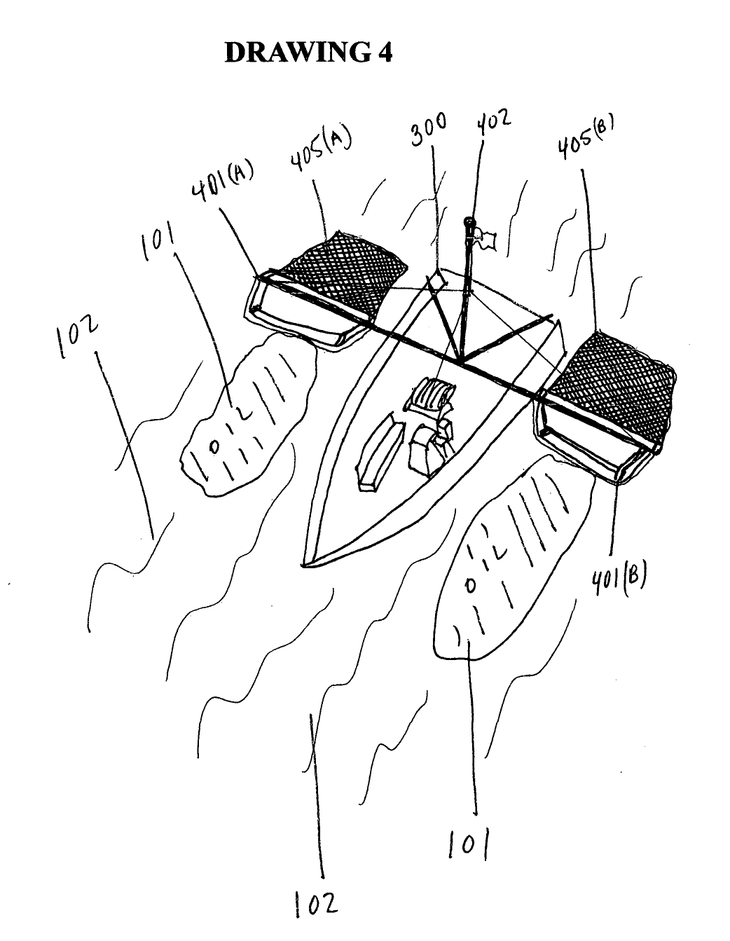

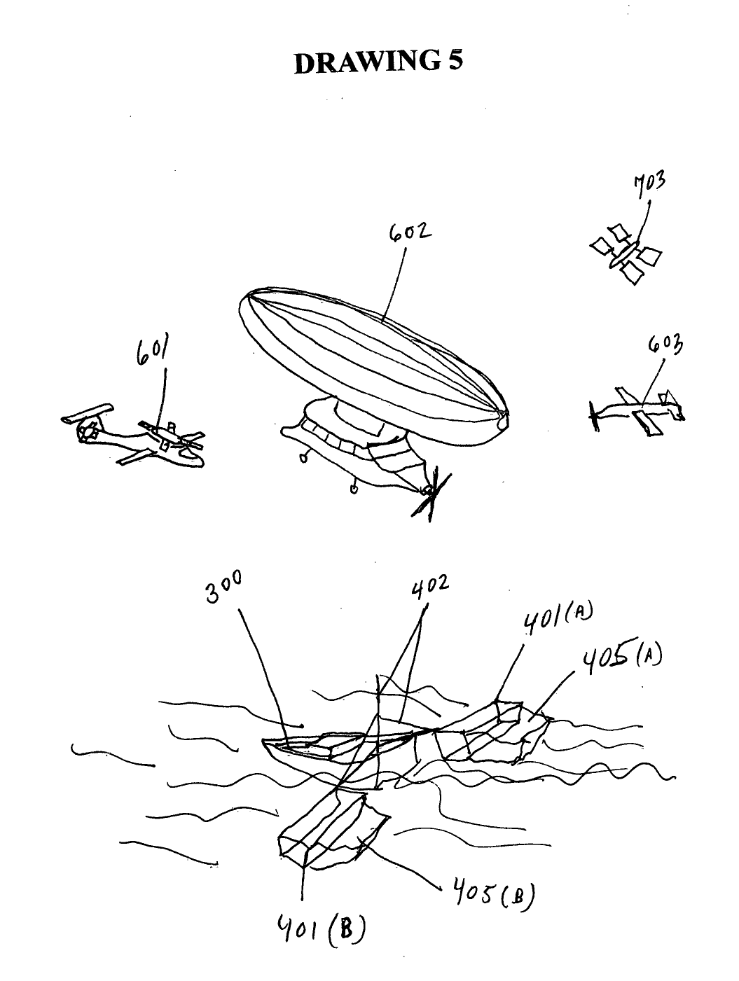

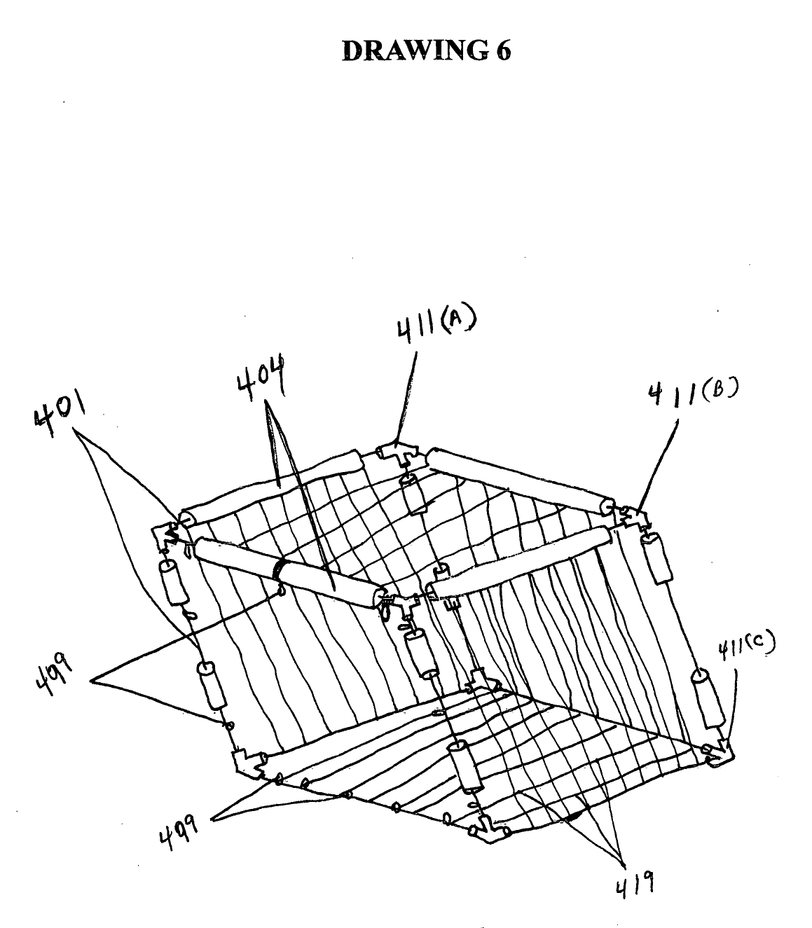

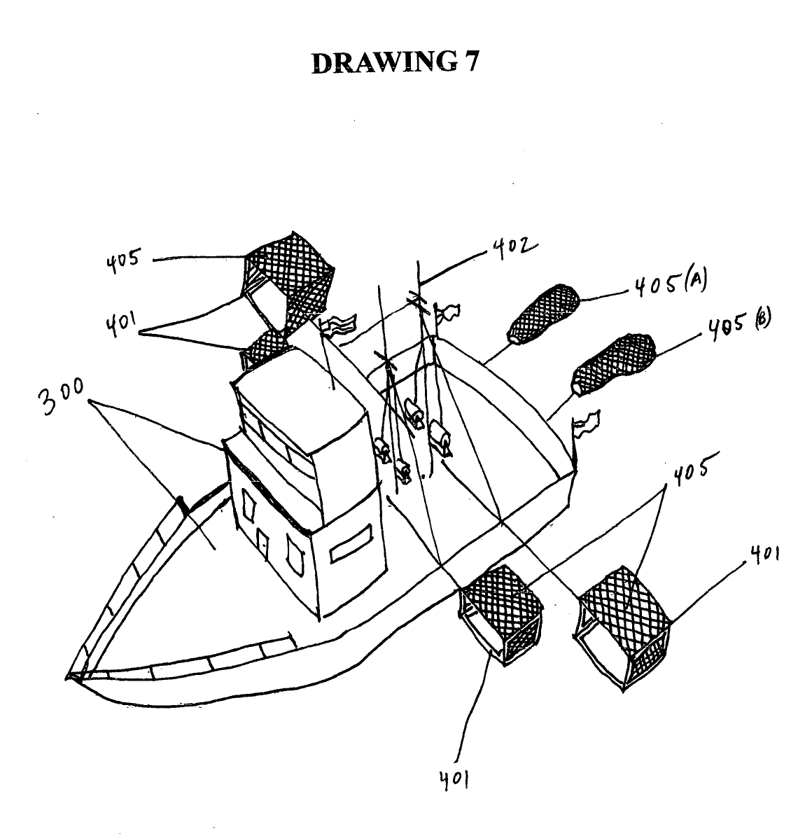

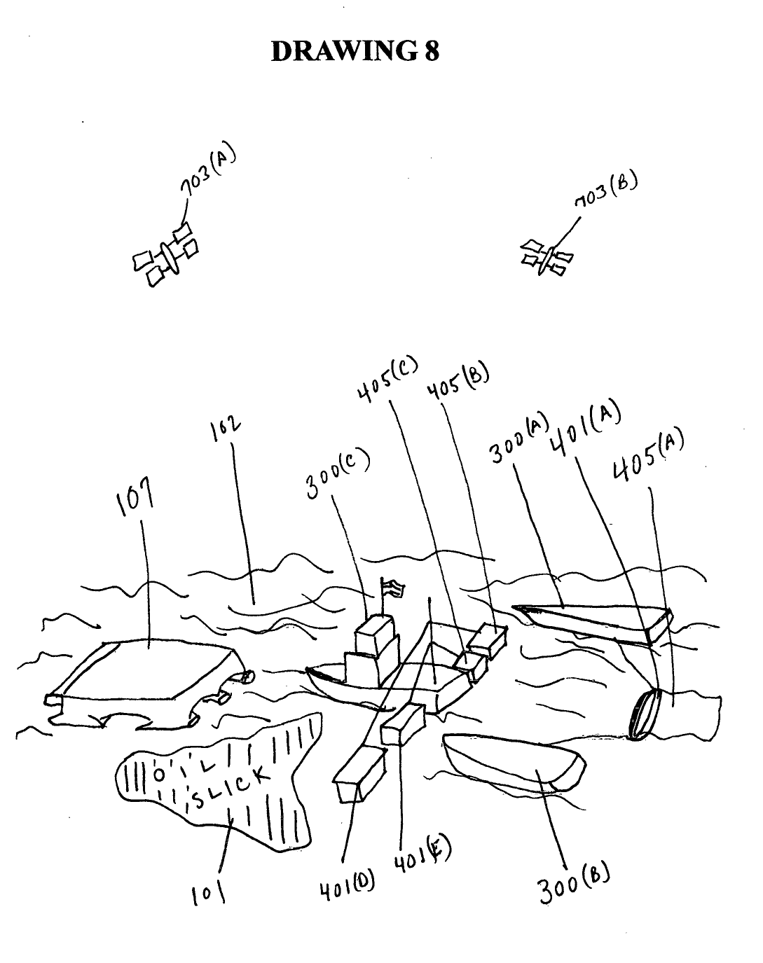

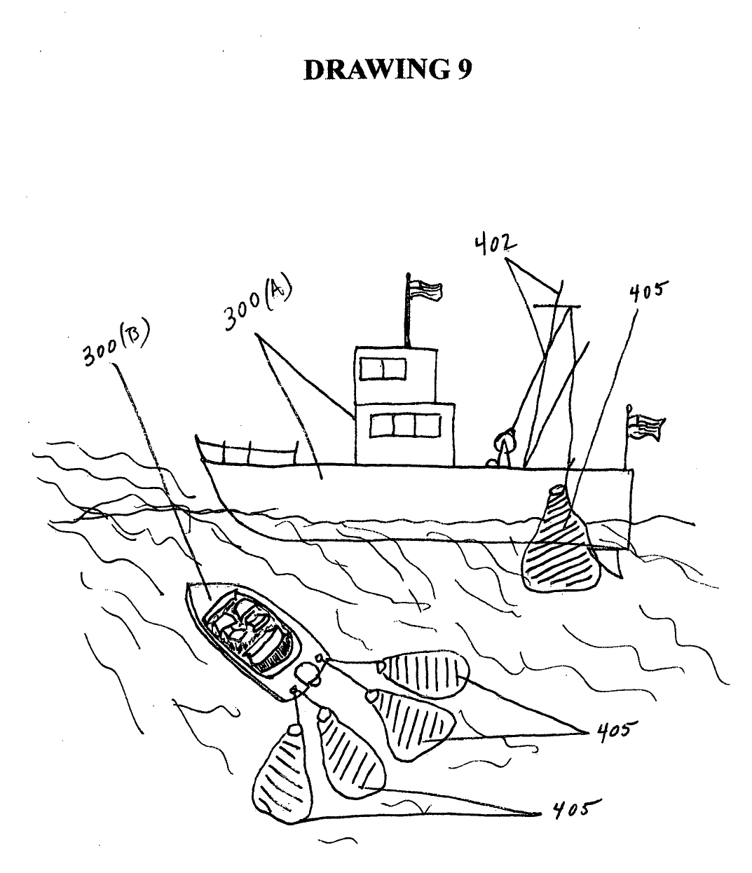

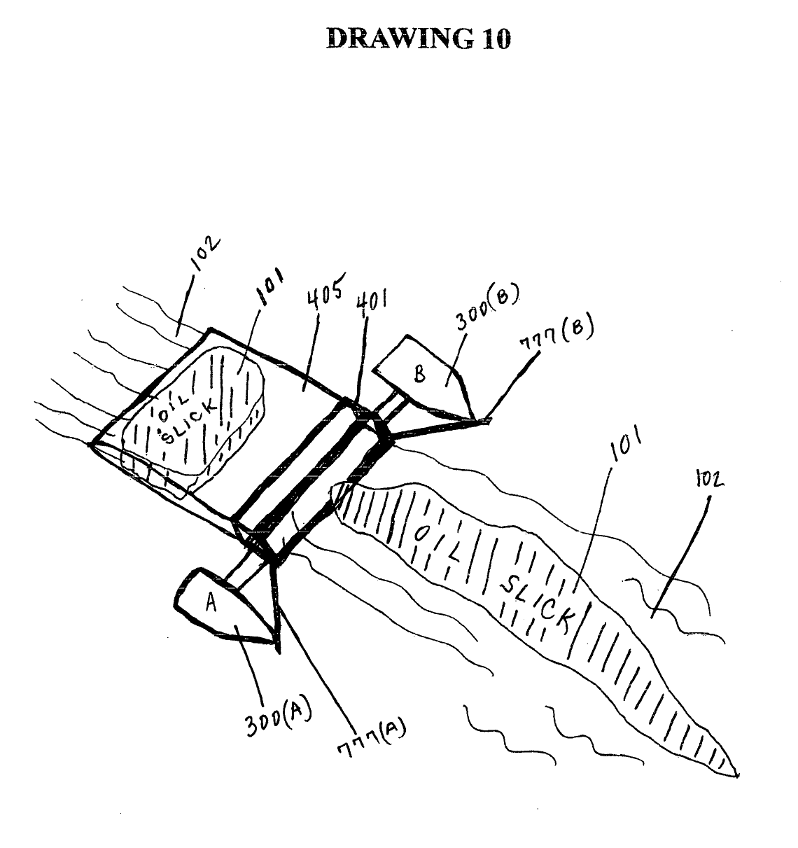

### RELATION TO PRIOR APPLICATION

This non-provisional patent application is based on and claims the benefit of the prior provisional application, U.S. Ser. No. 61/397,214 filed on date: Jun. 7, 2010.

### BACKGROUND OF THE INVENTION

### I. Field of The Invention

This non-provisional utility patent application is a new invention of a Oil Skim Netting 405 and Net Frame 401 shall be used as trolling or skimming options and or techniques for cleaning up oil and or contaminant spills in any body of water. This new invention is applicable for cleaning up oil spills in or from water in a more environmentally friendly way than by using much of the traditional equipment, processes, and or responses.

### SUMMARY OF INVENTION

This is a non-provisional utility patent application is for a new invention used for cleaning up oil spills in a body of water such as: oceans, rivers, lakes, marshes, swamps, ditches, canals, etc. For this application, the term ‘oil’ will be used to describe oil and or any contaminant having a specific gravity less than 1.0.

Recent spills and mishaps have led to search for new and better methods to clean up oil spills. Current methods simply take too long, are not effective or efficient, and or do little to actually separate the oil from the water. Other tools and equipment currently used, such as dispersant, can actually do more much harm to the environment than they are meant to solve. There are obvious deficiencies in the efforts used to date. Therefore, the need exists for adding new options and better oil spill clean-up equipment.

This invention is for a new type of netting 405 and net frames 401 which can be used for trolling, skimming, and or trawling. It is possible that this invention can be deployed by local fishermen, affected by the spill, who are accustomed to skimming, trolling, and or trawling in the same waters the spill is located in. This Netting and Net Frame system can easily be built and or added to several different kinds of shrimp, crab, etc. fishing vessels so that they can be converted on site for use by the fishermen and local people who are affected by the spill, so that they can be employed to help and clean up the spill.

### BACKGROUND AND PRIOR ART

One of the traditional or current method and or approaches for the oil clean up process has been to place large ‘containment booms’ out in the water. The ‘containment booms’ are objects which float on top of the water, they are set in formations to direct the flow of oil to collection areas, and act as a barrier between the non-contaminated water and the actual oily or contaminated water. These booms do little to actually separate and or clean the water. The booms are flimsy at best, and they are mostly a passive system that require a lot of man hours to operate.

Another method or approach to the spilled oil has simply been to use the booms to help gather the surface oil into a form or clump, and then perform a method called a ‘controlled burn’ or ‘in-situ burn.’ The controlled burn simply sets the over-contaminated or oily water on fire. The highly concentrated oil contaminant is on the water surface, and it is flammable. The controlled burns are very dangerous, as the enormous amount of oil virtually is surrounding every vessel out in the water.

A third method or approach that has been to date is to building ‘man made islands’ which are meant to separate the oily water from the delicate shorelines, swamps, marsh, etc., as well as to protect some other areas from the oily water. This type of process is very expensive, and it may cause unknown future problems. There are simply a lot of unknowns and variables associated with this type of relief operation, and the process would be expensive while doing nothing to separate the oil from the water.

The other inventions or techniques that have been used for past oil spills and similar contamination areas have been to spread human hair, animal hair, and or use other ‘Bio’ materials on the water to absorb or ‘eat’ the oil. Also products like cut grass and hay have been spread on the surface of the water, as well, hoping that they will absorb the oil (and or contaminant). This process works for some contaminants, but this process can simply be overwhelmed by the amount of oil leaked out, and the possible contaminants already present on the actual hay, hair, grasses, etc. such as weed killer or pesticides can often do more damage to the environment than the oil. For spills associated with large amounts of oil or contaminant, there just isn't enough hay and hair on hand to get the job done.

Other options for dispersing the oil have been attempted. Oil companies have used what is referred to as a ‘dispersant’ to contain or control the oil. Dispersants are usually spread by a airplane and or sprayed from ships. Dispersants are usually a liquid soap or other types of chemicals which can mend to the oil so that the oil forms clumps. This has sent workers to the hospital, and it has led to the workers having to wear actual gas masks as they work in the heat cleaning up the water. There are many unknowns related to the dispersants. Some of the unknowns are the current, short, medium, and long term effects of the chemicals on the fish and or any wetlands in the regions. Because the dispersants are usually spread by airplanes, there are also concerns for the birds and other flying species in the area as well.

Skimming techs and or equipment have also been used, and skimming is still needed and very useful. The skimming techs usually or normally consist of using deeper hulled vessels and trolling with or pulling a ‘J shaped’ Boom, ‘V shaped’ boom, or ‘teardrop shaped’ boom so that the booms help funnel the oil at the base of the (for example) ‘V’; and then the oil is suctioned out using some kind of throw pump which is tossed by the crew into the boom area. The pump sucks the oil from the water into containers in or on the vessels. Skimming is a good and often environmentally friendly way to clean the oil from the surface, however with the current vessels there are some places that the booming cannot be done or operate in due to the deeper hulls on the vessels. Also, there is a limited amount of oil that each vessels can take in.

When large spills happen, it often calls for hundreds of ships to skim for oil. New types of skimming vessels are needed that can take in more oil. And, new vessels and or new equipment are needed that have more shallow drafts which allows them go into more shallow waters, environmentally sensitive areas, and or swamps, marshes, near shoreline and shoreline areas, etc. to get pockets of oil. This non-provisional patent application will show a suitable invention which can hold large amounts of oil, they can be used from and or added to local vessels or boats normally used in the area where the spill is located for fishing; and many are more nimble and can even go in super shallow waters.

### BRIEF DESCRIPTIONS OF THE DRAWINGS

DRAWING 1 shows a exploded view of a Net 405 which allows water to pass through but not oil.

DRAWING 2 shows overhead front view of a Net 405.

DRAWING 3 shows a frontal view of a net frame 401 and net 405

DRAWING 4 shows a overhead view of a vessel 300 trolling with nets 405 and net frames 401.

DRAWING 5 shows a overhead large picture view of a blimp 602, drone helicopter 601, drone plane/jet 603, satellites 703 for GPS, and a overhead view of a vessel 300 skimming using nets 405 and net frames 401.

DRAWING 6 shows a exploded view of a net frame 401 with the opening on the left side.

DRAWING 7 shows a left side view of a vessel 300 trolling two nets 405 inside net frames 401 on both sides of the vessel.

DRAWING 8 shows a overhead view looking down on several vessels in a clean up operation. One vessel is pulling smaller nets and net frames, while two vessels are pulling one huge net 405 (A) and net frame 401 (A)

DRAWING 9 shows a overhead view of a vessel 300 (B) pulling filled nets 405 to a larger vessel 300(A) for disposal.

DRAWING 10 shows a overhead view of two vessels 300 A and B pulling a huge net 405 and net frame 401.

### DETAILED DESCRIPTION OF THE PREFERRED EMBODIMENT

This is a non-provisional utility patent application for a new type of oil spill skimming and collection system simply referred to in this application as a Net and Net Bag 405, and Net Frames 401; but called the Crouse Oil Spill Trolling Net and Net Frames. The nets are made up of porous fabric or material which has pores large enough to allow water to pass through but not oil. The net frames 401 are simply to hold the nets 405 so that the nets are open at one end where the oily water enters and then closed at the other so that the oil gets collected as the water passes through. The nets and net frames are very simple to use, they can be any size, and the net bags 405 can be made to work just like a trash bag and trash can. When the bag gets filled, you just simply take the bag off the net frame, and put a new bag in the frame and begin skimming again. The old bags can be dragged to a dumping location or hoisted into a tank, etc.

There are numerous materials and fabrics than are possible to be used for the netting, some are: mesh material often used for lawn furniture, wire screens used for making screen windows and doors, nylon netting, etc. There are numerous materials that can make up the net frames 401, and some are: aluminum, PVC, steel, titanium, carbon, fiberglass, etc. The frames and nets can be made any size, but because the oil is spilled in areas where fishermen normally work, and those fishermen will most likely be out of work due to the oil spill; the fishermen can be employed to clean up the spill. Because of this the net frames can be made especially tailored for the particular fishing vessels in the area.

The Drawings in this application are to show some possibilities for the net frames 401 and netting 405, but the designs can be altered for size and shape depending on the vessels used, and for tailoring to a specific water area or depth, etc.

Drawing 1 shows a exploded view of a piece of Netting 405 fabric which shows the weaving or porous material allowing only the water 102 to pass through, but not the oil 101.

Drawing 2 shows a open ended at 405 (B) net bag 405 having a drawstring 421 where the bag can be easily taken off a net frame and cinched. Also, the net bag has little loops around the entrance, a example being at 409, so to attach to a net frame (not shown).

Drawing 3 shows a net frame 401 with a net bag 405 attached and positioned inside the net frame. This particular version or design has the net bag hanging out of the rear, and with no backing. Other net frames are made with a backing and similar to a crab trap.

Drawing 4 shows a overhead view of a vessel 300 with a net frame 401 A and B similar to a shrimp vessel rigging and having net bags 405 A and B attached to the net frames; and being trolled through the water and skimming oil with the top part of the net frame at just above the water line while the rest of the net frames (both) are below the water line. The hoist 402 can raise and lower the nets and net frames.

Drawing 5 shows spotters used to spot the oil, such as blimps 602, helicopters 601, planes/drones 603, and satellites to mark the GPS. The nets can troll the waters blindly or the slick can be spotted with GPS coordinates given to the vessel crew so that the vessel 300 can go and skim exact locations and use the nets and net frames to collect the oil out of specific areas. Using spotters along with the nets and net frame skimmers, a greater skimming efficiency can be achieved.

Drawing shows a net frame 401 similar in shape to a crab trap. The opening is at the left side. Also in this drawing is floaters 404 to help the net frame float at a height just at or above the water line. One method for connecting the frame is to wield or glue, screw, etc. the ends together at points 411, examples 411 A and B and C. Loops for net connection are shown at 409 so that the Net bag (not shown in this drawing) can be attached. The bars, example 419 can be used and built into the frame to help and contain the netting. This type of Net frame can use net bags 405, or it can have permanent netting that can be suctioned out when filled, etc.

Drawing 7 is a really good example of a crab trap style net frame 401 having nets 405 and trolling or skimming using a transformed crab or shrimp fishing boat using hoists 402 to raise and lower the net frames and nets. Also, filled bags have been cinched and are shown at locations 405 A and B, as they are being towed to a collection area for off loading where they will be thrown away, burned, suctioned out and re-used, etc. A crab trap frame can be a simple aluminum frame that is 6 foot by 6 foot, 8 foot by 8 foot, etc.

Drawing 8 shows a overhead view of two types of nets and net frames working at once. The net frames can be made many sizes with different front end opening shapes. In this drawing, vessel 300 B and 300 A are shown pulling net frame 401 A and 405 A. Also, fishing vessel 300 C is pulling a crab traps style net frame and netting system. These vessels are working alongside a barge skimmer in or within a process.

Drawing 9 shows vessel 300 B pulling or towing four filled and cinched Net Bags 405 to the hoist vessel or dumping vessel 300 A. The bags can be hoisted 402 into tanks, burned, suctioned, etc.

Drawing 10 shows vessels 300 A and B using booms 777 A and B to help funnel oil 101 into a huge skimming net frame 401 mouth and net 405. The net captures and oil 101 and allows the water 102 to pass through.

I. What is claimed is a net frame 401, which is,
(a.) a simple frame made from materials such as: aluminum, PVC, steel, titanium, etc.
(b.) and formed or shaped for skimming oil and or put together using screws, wields, glue, etc.
(c.) and made with some added part around the opening for holding or attaching a net bag 405,
(d.) and made so that can be connected to a hoist 402 similar to the hoist on a crab or shrimp boat hoists, poles, and or riggings,
(e.) and made so that they can be pulled or trolled through the water with a part of the net frame 401 just above the water line while the other part is below the water line allowing for the oil to be collected and contained in the nets inside the frames,
(f.) and used in a way so that when the net bags 405 are filled, the bags can be taken out, cinched, and another put in its place easily so to continue trolling.
(g.) with a opening at one end holding the net bag 405 open, and having the option of having the net frame open or closed in the rear, so that the whole net bag is in the net frame or so that a portion of the net bag hangs rearward beyond the net frame:

II. What is claimed is a Net or Net Bag 405,
(a.) made from a material such a mesh, wire, nylon, etc. and
(b.) and having a weaving and or porous make-up which when used to troll for oil, the water is allowed to pass through but not the oil,
(c.) and made to fit on the net frames 401 so that they attach at one end with and are held open by the net frame 401 while the closed in can either be inside the net frame or hanging or extending beyond the net frame.
(d.) having the option of having a drawstring attached so that when the nets are filled with oil they can easily be cinched and dragged behind a vessel to a collection location and or hoisted via hoist 402 into a container, etc.
(e.) having the option of being made specifically for a net frame 401, but for both to be made in any size and or shape,
(d.) having the option of using the Net Bags and Net frames in a trolling or skimming situation in a way similar to a trash can and trash bag where then filled, a bag can be taken out of the net frame 410, cinched, removed, and another new net bag replaced, while the filled bags are pulled behind the vessel and or another vessel comes and pulls away the filled bags taking them to a disposal location.

III. A net 405 and net frame 401 system is a system for skimming which can be used to convert fishing vessels 300 operated by area fishermen so to help or assist in the oil spill clean-up efforts,
(a.) so that they can be employed while their fishing locations are out or primarily shut down due to a spill,
(b.) so to utilize all the possible vessels on location to assist in the spill containment,
(c.) to utilize the local fishermen who have knowledge of the area in spill containment,
(d.) to have more options for use in environmentally sensitive areas where new methods for collection are needed, etc.
(e.) so that the local fisherman can troll with the nets 405 and net frames 401 attached to their vessels in a similar way and with a similar technique as they normally use when trolling or trawling for fish, crab, shrimp, etc. with their own nets or traps.
